(19) United States
(12) Patent Application Publication
(10) Pub. No.: US 2012/0107496 A1
(43) Pub. Date: May 3, 2012

(54) METHOD OF GENERATIVELY MANUFACTURING A THREE-DIMENSIONAL OBJECT WITH BROACHING ELEMENTS AND METHOD OF GENERATING A CORRESPONDING DATA SET

(75) Inventor: Axel Thoma, Gilching (DE)

(73) Assignee: EOS GmbH Electro Optical Systems, Krailling (DE)

(21) Appl. No.: 13/098,726

(22) Filed: May 2, 2011

(30) Foreign Application Priority Data
May 5, 2010 (DE) 10 2010 019447.6

(51) Int. Cl. B05D 1/36; G06F 17/50; B05D 5/00

(52) U.S. Cl. 427/202; 703/1

(57) ABSTRACT

The present invention relates to a method of generatively manufacturing a three-dimensional object (3) by means of a device, comprising the following steps: a) layerwise applying a powdery material (11) onto a support (5) of the device or a previously applied layer; b) selectively solidifying the powdery material (11) by energetic radiation (8′) at locations corresponding to the cross-section of the object (3) in the layer, c) repeating the steps a) and b) until the object (3) is completed. The object (3) has at least one cavity (13), which opens to an opening (14) at the surface of the object (3), and the powdery material (11) is solidified such that a broaching member (12) is formed, which extends in the cavity (13) and can be withdrawn through the opening (14) from the cavity. The invention also relates to an associated method of generating a data set of the three-dimensional object (3).

The present invention relates to a method of generatively manufacturing a three-dimensional object and to a method of generating a corresponding data set.

DE 199 37 260 B4 describes a known method and device for generatively manufacturing a three-dimensional object comprising the following steps: a) layerwise applying a powdery material onto a support of the device or a previously applied layer; b) selectively solidifying the powdery material by energetic radiation at locations corresponding to the cross-section of the object in a layer, c) repeating the steps a) and b) until the object is completed.

DE 295 06 716 U1 describes a known method of post-processing a generatively manufactured three-dimensional object, wherein the object is blown off by an air pressure gun in order to remove remaining powder.

It is the object of the present invention to provide a method of generatively manufacturing a three-dimensional object, by which the removal of remaining powder inside the three-dimensional object is simplified. This object is achieved by the method having the features of claim 1 and by the method of generating a data set having the features of claim 9. Advantageous further developments are defined in the dependent claims.

The invention has the advantage that the three-dimensional objects can be released from the inside remaining powder without substantial burden. The broaching member, for example in the shape of a thread, enables releasing the remaining powder in more or less angled cavities or passages of the object to generate at least a pilot channel. This pilot channels allows a minimum flow, when an airflow with or without grit is applied such that the whole cross-section of the cavity and the channel, respectively, are exposed little by little.

The broaching member is a component in the data which are used during manufacturing the object. The broaching member is placed such that it does not contact the walls of the cavity. In cavities, which have the shape of a channel of uniformly extending walls, the broaching member can extend exactly or at least approximately along the neutral axis of the channel. For each cavity in the object, a separate broaching member can be placed, wherein it can also be arranged in two parts in one cavity, which means the broaching member can be divided at a branching point which represents an angular point appropriate for broaching, and it can be withdrawn to anyone of both openings of the cavity.

The broaching member can have the shape of a thread, but it is not restricted thereto. Each kind of geometrical shape can be used, which is a component of the data set for the objects and can expose a pilot channel. The broaching member can have the shape of a strip for flat passage cross-sections, a wavy geometry or a helical geometry or a combination thereof. Thereby, it is even possible to release very angled cavities and passages or curved passages, respectively, from the remaining powder.

Further features and aims of the invention can be gathered from the description of embodiments on the basis of the enclosed drawings. In the figures show:

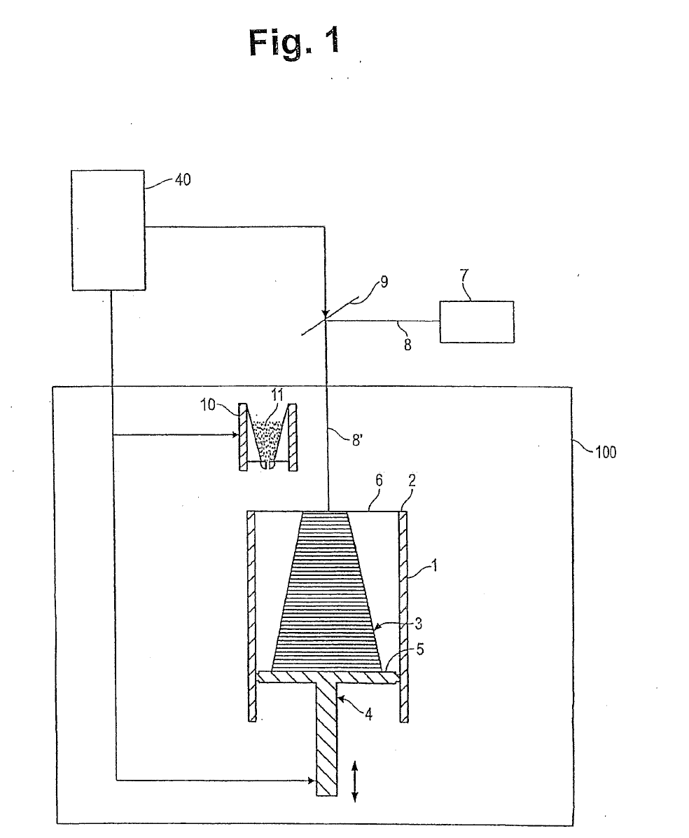

FIG. 1 a schematic view of a device for manufacturing a three-dimensional object; and

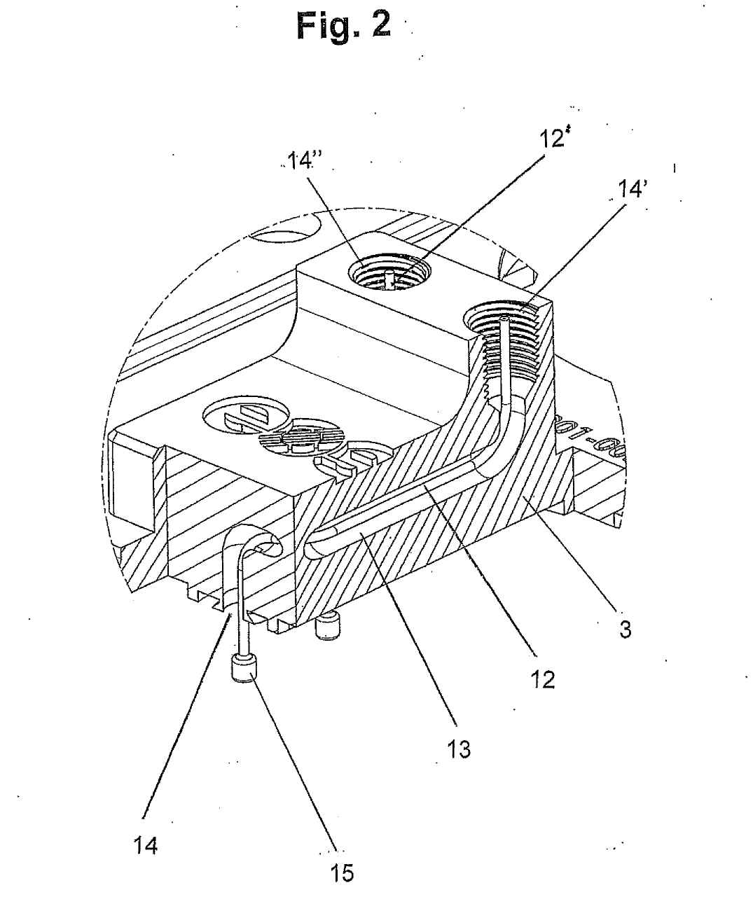

FIG. 2 a cross-section view of a three-dimensional object which is manufactured by the device according to FIG. 1.

FIG. 1 shows a schematic view of a device for manufacturing a three-dimensional object 3 which is exemplarily formed as a laser sintering device.

The laser sintering device comprises a frame 1 which opens at the top and having thereon a support 5 which is movable in the vertical direction and supports the three-dimensional object 3 to be manufactured. The frame 1 surrounds with the upper portion 2 thereof a building field 6. Preferably, the frame 1 and the support 5 form an exchangeable replacement frame which can be removed from the laser sintering device. The support 5 is connected to a lifting mechanics 4 which moves it at least below the plane of the building field 6 in the vertical direction such that the upper side of the respective layer, which is to be solidified, lies in the plane of the building field 6.

Further, a coater 10 for applying a layer of a powdery material 11 is provided. As powdery material 11, all laser sinterable powders can be used, such as powder of synthetics, metals, ceramics, molding sand and compound materials. As metalliferous powdery material, any metals and the alloys thereof as well as mixtures with metalliferous components or with non-metalliferous components come into question.

The coater 10 is moved to a predetermined height above the building field 6, so that the layer of the powdery material 11 lies in a defined height above the support 5 and above the lastly solidified layer, respectively. Further, the device comprises a radiation device in the shape of a laser 7 which generates a laser beam 8, 8′ which is focussed by a deflection means 9 to arbitrary points in the building field 6. Thereby, the laser beam 8, 8′ can selectively solidify the powder material 11 at the locations corresponding to the cross-section of the object 3 to be manufactured.

The laser sintering device may comprise a heating device (not shown) above the building field 6, in order to pre-heat a newly applied powdery layer onto a temperature close to the process temperature of the powdery material 11, which is required for solidification.

Reference sign 100 designates a housing, in which the frame 1, the support 5 and the coater 10 are arranged. Preferably, the housing is gas-tightly formed and has in the upper area an inlet for introducing the laser beam 8, 8′. Preferably, an inert gas is introduced into the housing 100. Further, a control unit 40 is provided, by which the device can be controlled in a coordinated manner to perform the building processes and to control the energy impact by the laser 7. The control unit 40 uses data sets of the object 3 for manufacturing the object 3, which defines the geometry of the object 3 such as CAD-data.

During operation of the device, the support 5 is moved in a first step by the lifting mechanics 4 downwards, until the upper side thereof lies in a desired thickness of a first powdery layer below the plane of the building field 6. Then, the coater 10 applies and smoothes a first layer of the powdery material 11 onto the support 5. If the heating device is provided, the temperature of the uppermost powdery layer 11 can be globally pre-heated by the heating device to some ° C. below the process temperature which is required for solidification. Thereafter, the control unit 40 controls the deflection means 9 such that the deflected laser beam 8, 8′ selectively impinges on the locations of the layer of the powdery material 11, which shall be solidified. Thereby, the powdery material 11 is solidified and sintered, respectively, at these locations, so that the three-dimensional object 3 is generated here.

In a next step, the support 5 is lowered by the lifting mechanics 4 by the desired thickness of the next layer. By the coater 10, the second powdery material layer is applied, smoothened and selectively solidified by means of the laser beam 8, 8′. These steps are repeated as often as the desired object 3 is manufactured.

FIG. 2 shows a cross-section view of a three-dimensional object 3 which is manufactured in the device according to FIG. 1.

The object 3 has a cavity 13 which opens to an opening 14 at the lower surface of the object 3. During manufacturing the three-dimensional object 3, the powdery material 11 has been solidified such that a broaching member 12 is additionally formed, which extends in the cavity 13 and can be withdrawn through the opening 14 from the cavity 13. In the depicted embodiment of FIG. 2, the cavity 13 also opens to a second opening 14′ at the upper surface of the object 3, and the broaching member 12 can also be withdrawn from the cavity 13 through the second opening 14′.

The broaching member 12 is therefore no intrinsic component of the final object 3. After the object 3 is completed by the laser sintering process and the broaching member 12 has been withdrawn from the opening 14 of the cavity 13, a pilot channel is generated. The pilot channel simplifies the removal of remaining powdery material 11 which must be removed from the cavity 13 after the laser sintering process. After withdrawal of the broaching element 12, a fluid flow is applied to the opening 14 and to the thus generated pilot channel, so that the powdery material 11 in the cavity 13 is removed and the whole cross-section of the cavity 13 is exposed little by little. For example, the fluid flow can be pressurized air with or without grid, which is blown along the surface of the object 3, thereby sucking the powdery material 11 by the dynamic pressure similar to a Venturi-nozzle, for example from the opening 14. Thereby, the air is sucked through the other opening 14′ into the cavity 13. Alternatively, the pressurized air can be directly blown into the opening 14. Thereby, the remaining powdery material 11 is blown out of the other opening 14′.

However, the fluid flow is not restricted to pressurized air, because also other gases such as inert gas and also liquids such as water or oil can be used.

In the depicted embodiment, the broaching member 12 has the shape of a thread. However, the invention is not restricted to this shape, because the broaching element can also have the shape of a strip, a wave or a helix or any other suitable shape. For example, the shape of the wave can oscillate in a sinusoidal wave form, in a rectangular shape or in a serrated shape.

Preferably, the broaching member 12 is bendable, if the cross-section of the broaching element 12 is appropriately dimensioned in view of the used powdery material. This is advantageous during withdrawal of the broaching element 12 from angled cavities. For example, the broaching element 12 can be stretched during withdrawal.

It is also conceivable to form the broaching element 12 with joints or as a chain which consists of several chain links.

The broaching member 12 may comprise pushing members or barbs (not shown) which entrain a larger amount of the powdery material 11 during withdrawal of the broaching element 12.

In the depicted embodiment, the broaching member 12 has a grasping member 15 which simplifies grasping the broaching member 12. However, the grasping element 15 can also be omitted.

As it can be gathered from FIG. 2, the broaching member 12 does not contact the walls of the cavity 13. In the depicted embodiment, the cavity 13 has a uniformly extending wall and therefore the shape of a passage 13, wherein the broaching member 12 preferably extends substantially along a neutral axis of the passage 13. Thereby, an ideal course of the pilot channel is secured. However, the course of the broaching member 12 must not necessarily extend along the neutral axis of the passage 13.

In FIG. 2, a second broaching member 12′ is additionally depicted, which is separately formed from the first broaching member 12 and can be withdrawn from a third opening 14″.

Although not depicted in the embodiment, the broaching member 12 may comprise a branching point at which the broaching member 12 proceeds in different branches of the cavity of the object 3. Preferably, the broaching member 12 is then withdrawn from that opening of the object, which is associated to the non-branched part of the broaching member.

It is also conceivable to form several separate broaching members 12 in one cavity 13 of the object 3. It is also conceivable that the separate broaching members 12 then extend partly in different branches of the cavity 13.

The present invention also relates to a method of generating a data set of a three-dimensional object 3 which is manufactured by means of a method of generatively manufacturing a three-dimensional object. For example, the data set consists of CAD-data of the object 3, by which the laser sintering apparatus manufactures the three-dimensional object 3. A laser sintering apparatus performs a manufacturing method, by which the powdery material 11 is repeatedly and layerwise applied onto a support 5 of a device or a previously applied layer, and the powdery material 11 is solidified by energetic radiation 8′ at locations corresponding to the object 3. The object 3 has at least one cavity 13 which opens to an opening 14 at the surface of the object 3.

The inventive method of generating a data set of a three-dimensional object 3 comprises the following steps.

First, a data set is generated in a conventional manner, which defines the geometry and the dimensions of the completed three-dimensional object 3. For example, these can be the conventional CAD-data of the object 3.

In addition thereto, the data set is completed by data which define the geometry and the dimensions of a broaching member 12 which extends in the cavity 13 and can be withdrawn through the opening 14 from the cavity 13. Thereby, the broaching member 12 is manufactured by the laser sintering apparatus at the same time with together the intrinsic object 3.

The scope or protection is not restricted to the depicted embodiments, but it includes further modifications and alterations provided that they fall within the scope as defined by the enclosed claims.

For example, the inventive device can not also be applied in laser sintering, but to all powder-based generative methods in which a material and a powdery material, respectively, is used in each layer to be applied, which is solidified for example by the energetic radiation. The energetic radiation must not necessarily be a laser beam 8′, but it can also be an electron beam or a particle beam, for example. Moreover, a radiation over the whole surface is possible, for example of a mask. Instead of the energetic radiation, an adhesive and a binder, respectively, can also be applied to the desired locations, which selectively adheres the powdery material.

1-10. (canceled)

11. A method of generatively manufacturing a three-dimensional object by means of a device, the method comprising the following steps:
a) applying a powdery material layerwise onto a support of the device or a previously applied layer;
b) selectively solidifying the powdery material at locations corresponding to the cross-section of the object in a layer,
c) repeating the steps a) and b), until the object is completed;
wherein the object comprises at least one cavity which opens to an opening at the surface of the object; and
wherein the powdery material is solidified such that a broaching member is formed, which extends in the cavity and can be withdrawn from the cavity through the opening.

12. The method according to claim 11, further comprising the steps of:
withdrawing the broaching member from the opening of the cavity in order to form a pilot channel, after the object has been completed;
applying a fluid flow to the opening and to the pilot channel such that the powdery material in the cavity is removed.

13. The method according claim 11, wherein the broaching member has the shape of a thread, a strip, a wave, a helix or a combination thereof.

14. The method according to claim 11, wherein the broaching member comprises pushing members or barbs.

15. The method according to claim 11, wherein the broaching member comprises grasping members.

16. The method according to claim 11, wherein the broaching member does not contact the walls of the cavity, and in a cavity having the shape of a passage of uniformly extending walls, the broaching member extends substantially along a neutral axis of the passage.

17. The method according to claim 11, wherein the cavity opens to at least two openings at the surface of the object, and the broaching member can be withdrawn from the cavity at both openings.

18. The method according to claim 11, wherein the broaching member comprises a branching point, and wherein the broaching member proceeds in different branches of the cavity of the object.

19. The method according to claim 11, wherein broaching members are formed in more than one cavity of the object.

20. A method of generating a data set of a three-dimensional object which is manufactured by means of a method of generatively manufacturing a three-dimensional object, wherein the method of generatively manufacturing repeatedly and layerwise applies a powdery material onto a support of a device or a previously applied layer, and the powdery material is solidified at locations corresponding to the object;
wherein the object comprises at least one cavity which opens to an opening at the surface of the object,
wherein the method of generating the data set comprises the following steps:
generating a data set which defines the geometry of the completed three-dimensional object; and
supplementing the data set by data which define the geometry of a broaching member which extends into the cavity and can be withdrawn from the cavity through the opening.
